(19) United States
(12) Patent Application Publication
(10) Pub. No.: US 2018/0196993 A1
(43) Pub. Date: Jul. 12, 2018

(54) Authentication Process for Post-1942 Norman Rockwell Paintings

(71) Applicant: Robert Louis Stupack, Novato, CA (US)

(72) Inventor: Robert Louis Stupack, Novato, CA (US)

(21) Appl. No.: 15/863,953

(22) Filed: Jan. 7, 2018

(51) Int. Cl. G06K 9/00; G06F 8/61; G06F 17/30

(52) U.S. Cl. CPC G06K 9/00161; G06K 9/00483; G06F 17/3007; G06F 8/61

(57) ABSTRACT

Every Norman Rockwell original painting created after 1942, contains an anti-forgery technique based upon the concept of Steganography. Mr. Rockwell created and employed this method to prevent forgers from reproducing his pictures and selling them as originals or creating artwork that could be falsely attributed to him.

This authentication process reveals the hidden initials NR and upon subsequent magnification, the syllables comprising the names, Norman and Rockwell and the year of the painting's completion in Mr. Rockwell's printed handwriting styles. This authentication process only takes a few minutes and requires a .jpeg image measuring at least 1,000×1,035 mm of any post-1942 Norman Rockwell original painting plus a computer capable of running Adobe Photoshop, the IrfanView software program loaded with the Adobe 8BF plugin called, “Smart Curve” and the GIMP software program.

### BACKGROUND OF THE INVENTION

The 1930's saw rapid technological advancements in the field of photography and the standardization of color models by the International Commission on Illumination (CIE). Norman Rockwell realized that some of these innovations might also be applicable painted artwork.

In addition to being a renowned illustrator and painter, Mr. Rockwell was an avid photographer who developed his film. He publically acknowledged the fact that he worked from photographs of his subjects rather than having them pose for long periods of time while he painted.

In 1938, Mr. Martin J. Weber, created a variety of innovative methods for photography and filed a patent application for a process called, “Posterization.” Mr. Weber's invention caused two-dimensional photographs to appear as three-dimensional images that sprung off the page. Posterization is a highly technical process that falls into the category of color quantization. It typically uses a fixed palette (RGB or CMYK) and then minimizes the number of colors used within the same color model. The process involves converting black-and-white or color photographs into a series of three negatives, each designated for a different color. When the three negatives are printed together, each slightly off-register, the final product appears to be multi-dimensional.

Mr. Rockwell learned about Mr. Weber's invention and realized that he could create a unique anti-forgery technique for use in his painting that combined the latest advancements in color standardization and photographic technology. His application would be a blend of Steganography and Posterization.

Since Posterization only works on colors within the same color model, he used RGB model paints to hide his initials and the syllables of his name amidst the CMYK paint colors he used. The human eye would not be able to perceive the slight difference between the CMYK colors and RGB colors and any variation in shade between the two types of paint would not appear on a photograph taken with a camera because all cameras work on the RGB color model. The only way to see the hidden information would be to take a picture of the painting and convert that photograph into a third CIE approved model known as, HSV. The final step was to use the HSV transformed image and subject it to the process of Posterization.

Around 1940, Mr. Rockwell began experimenting with this idea. He placed the initials NR and the syllables, “nor,” “man,” “rock” and “well” near each other. For unknown reasons, the syllables “man” and “well” always appear in reverse as “nam” and “llew.” In many paintings, the initials are also in reverse as “RN” rather than “NR.” The style of the lettering he used for the initials and syllables varies significantly from painting to painting, and the size of the initials and letters is always small in comparison to the dimensions of the picture. Every painting created after 1942 contains these authentication features.

Mr. Rockwell mastered this technique in short time, and by 1945 he enhanced the effectiveness of the method by painting his initials and syllables of his name multiple times on his paintings!

### BRIEF SUMMARY OF THE INVENTION

The definition of Steganography is the art of hiding data in a cover medium. In this authentication process, paint is the cover medium and the method to reveal the data relies upon the technical differences between three color models that were developed by the International Commission on Illumination in the 1930's.

The RGB model is additive and represents the way that light creates colors. The name of the model comes from the initials of the three additive primary colors, red, green, and blue. The primary purpose of the RGB color model is for the sensing, representation, and display of images in electronic systems like cameras, televisions and computer monitors.

The CMYK model works the opposite way and is subtractive. When you start with nothing (white paper), and as you add more colors, they eventually turn black. CMYK is an acronym for the standard colored inks used by printers: cyan, magenta, yellow and black.

The HSB/HSV color model (Hue, Saturation, Value) defines a color space regarding Hue. This color space describes colors (hue or tint) regarding their shade (saturation or amount of gray) and their brightness value. Some color pickers use the acronym HSB, which substitutes the term “Brightness” for value, but HSV and HSB are the same color model. Photoshop uses HSB.

Mr. Rockwell's steganographic process demanded in-depth knowledge of the differences between the CMYK, RGB and HSB/HSL Color Models and the technical aspects of a process known as Posterization,

During Mr. Rockwell's lifetime, forgers worked from photographs of a painting. Mr. Rockwell's process used CMYK color model paints that closely matched the RGB color model to paint his initials, the syllables of his name and the year of completion. The slight difference between the RGB and CMYK color model paints was indistinguishable to the human eye and was invisible in photographs because all cameras work on the RGB color model.

Revealing the hidden information requires converting a large format .jpeg image of a Norman Rockwell painting completed after 1942 into the CYMK color model and then taking the CMYK version image and converting it into HSB/HSV color model. The HSB/HSV version of the .jpeg image is then subjected to the Posterization process using any computer to reveal the hidden information. Mr. Rockwell's anti-forgery technique employed the most advanced technological methods available in the late 1930s.

Use of this authentication process will be of great value to Museums, Auction Houses, Galleries, and Individuals. It will prevent the purchase of forgeries and can also be used to verify the authenticity of post-1942 Rockwell paintings already held in collections. Museum curators and American painting experts can avoid embarrassing situations similar to the 2006 discovery that an impostor of Mr. Rockwell's 1954 painting, Breaking Home Ties was on exhibit at the Norman Rockwell Museum.

### BRIEF DESCRIPTION OF DRAWINGS

The patent or application file contains at least one drawing executed in color. Copies of this patent or patent application publication with color drawing(s) will be provided by the Office upon request and payment of the necessary fee.

1. Image of the authentic Breaking Home Ties.

2. Image of the impostor Breaking Home Ties.

3. Image of the authentic Breaking Home Ties after using Adobe software to convert to the CMYK Color Model.

4. Image of the impostor Breaking Home Ties after using Adobe software to convert to the CMYK Color Model.

5. Image of the authentic Breaking Home Ties after using Adobe software to convert to the CMYK Color Model and IrfanView software with the Adobe 8BF Plug-in Smart Curve to convert the image to the HSB/HSV Color Model.

6. Image of the impostor Breaking Home Ties after using Adobe software to convert to the CMYK model and Irfanview software with the Adobe 8BF Plug-in Smart Curve to convert the image to the HSB/HSV Color Model.

7. The authentic Breaking Home Ties after using Adobe, IrfanView and GIMP software to Posterize—Level 3. NR/RNs appear on head, hands and suitcase.

8. The imposter Breaking Home Ties after using Adobe, IrfanView and GIMP software to Posterize—Level 3. This shows that the initials NR/RN do not appear anywhere in the picture.

9. Large format .jpeg image of the original painting, Voyeur.

10. Image of Voyeur after using Adobe software to convert the image to the CMYK Color Model.

11. Image of Voyeur after using Adobe software to convert to the CMYK model and Irfanview software with the Adobe 8BF Plug-in Smart Curve to convert the image to the HSB/HSV Color Model.

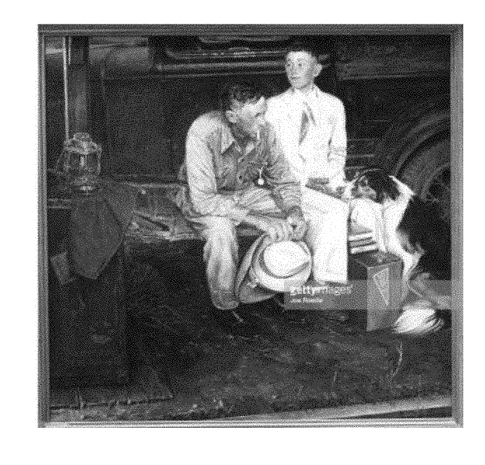

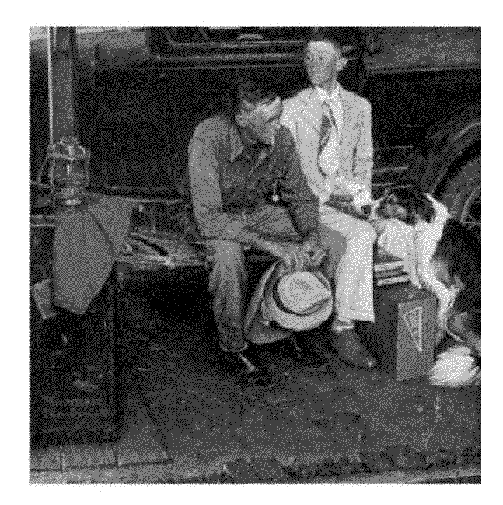

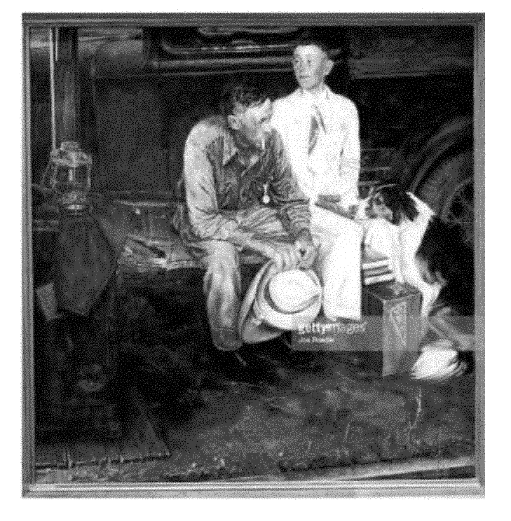

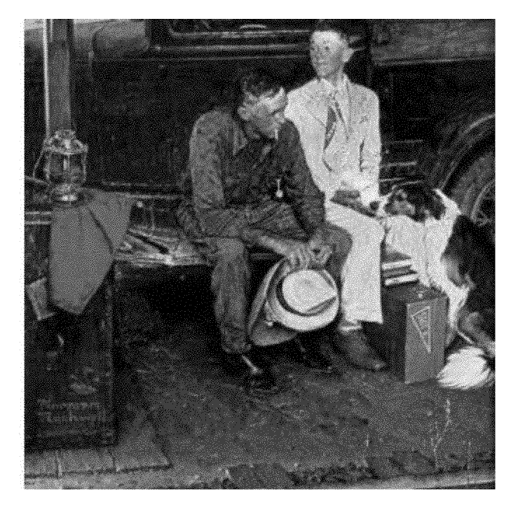

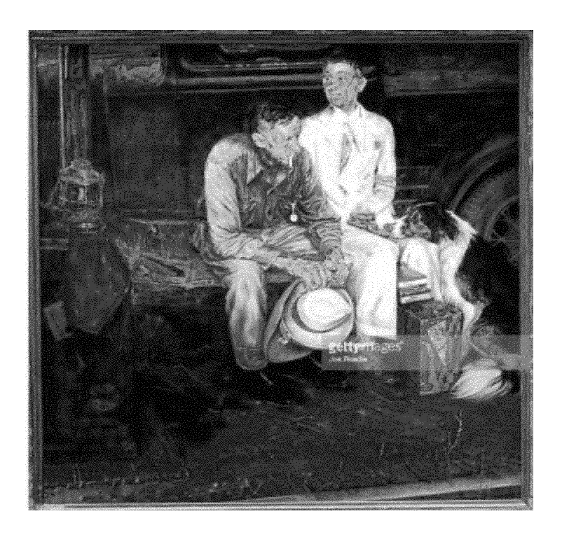

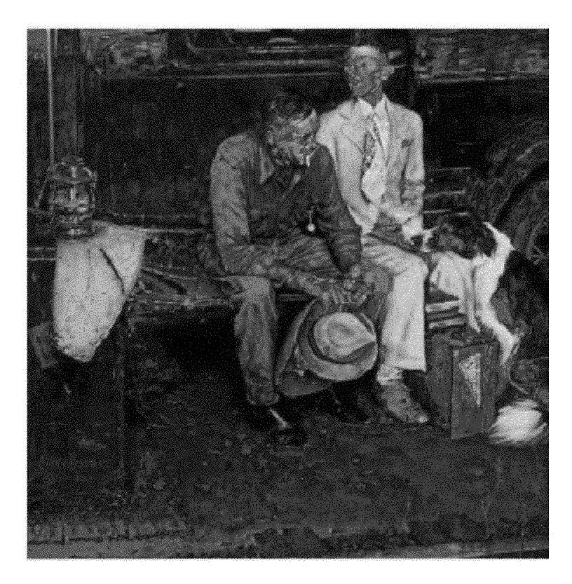

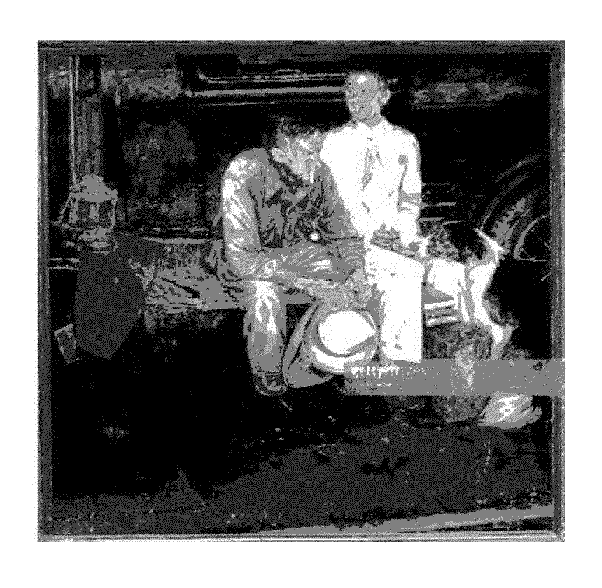

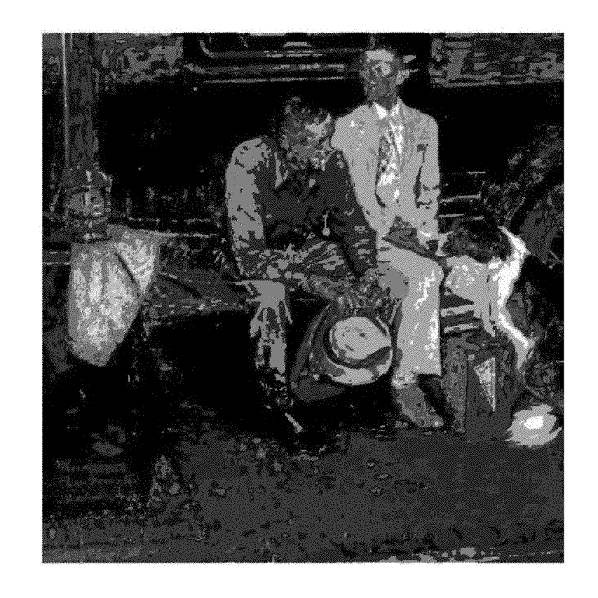

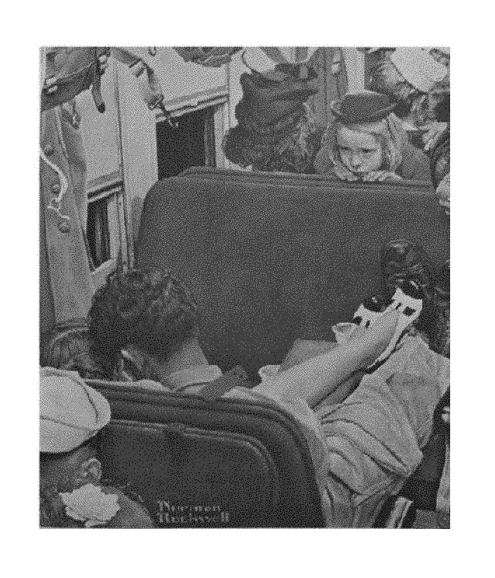

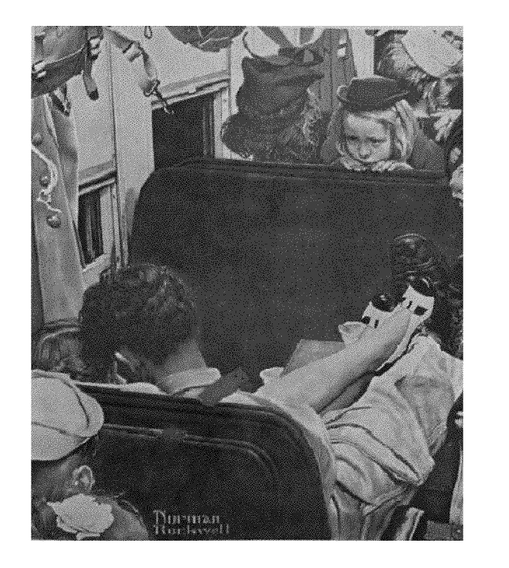

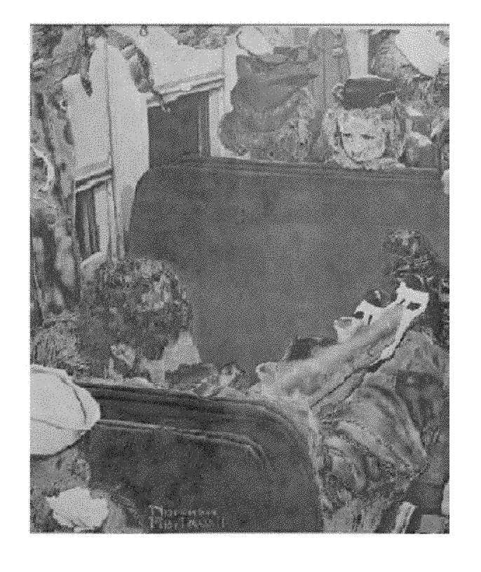

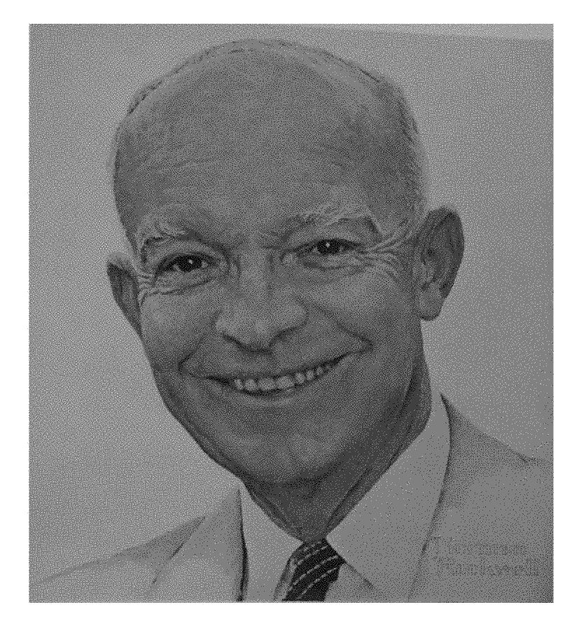

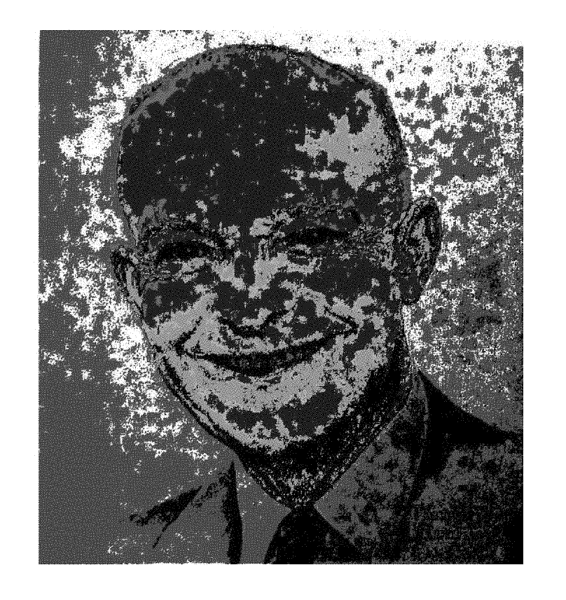

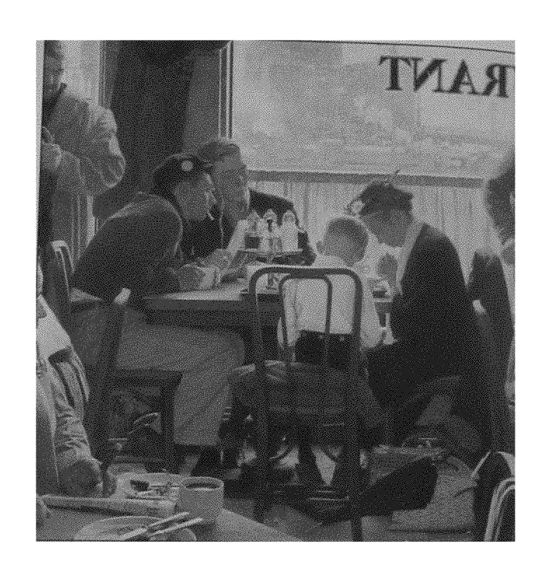

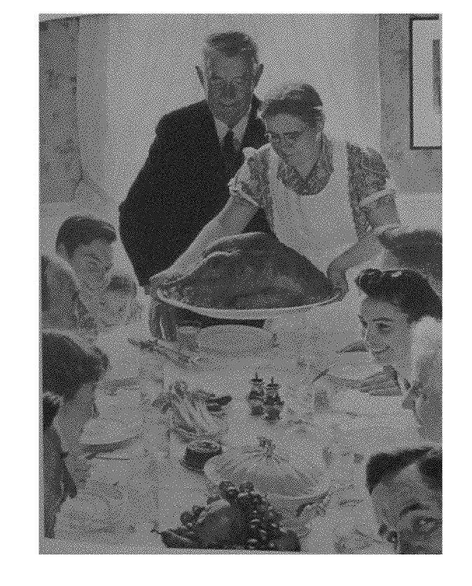

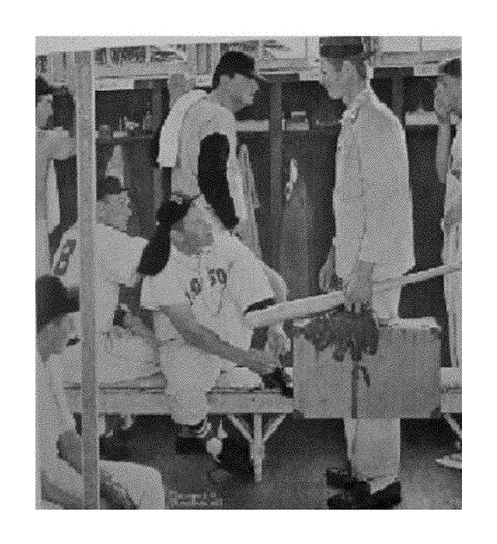

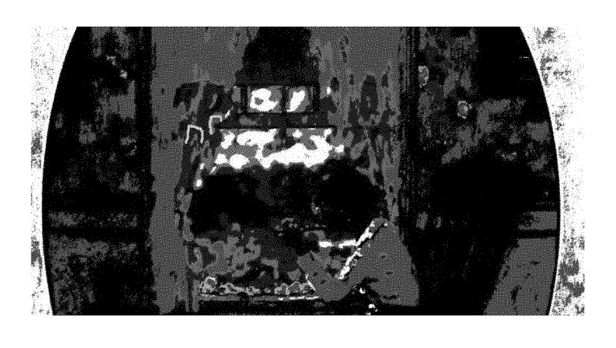

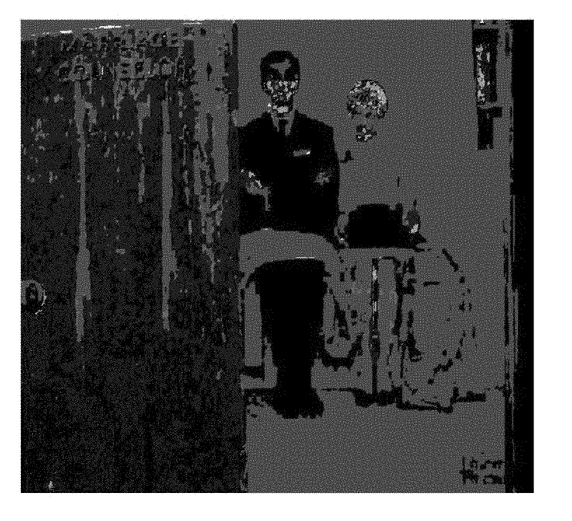

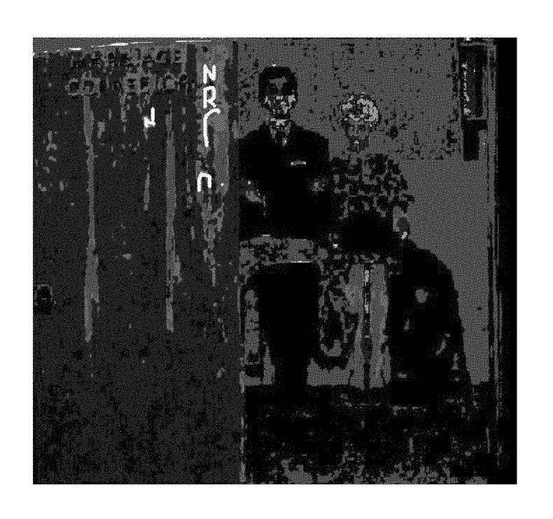

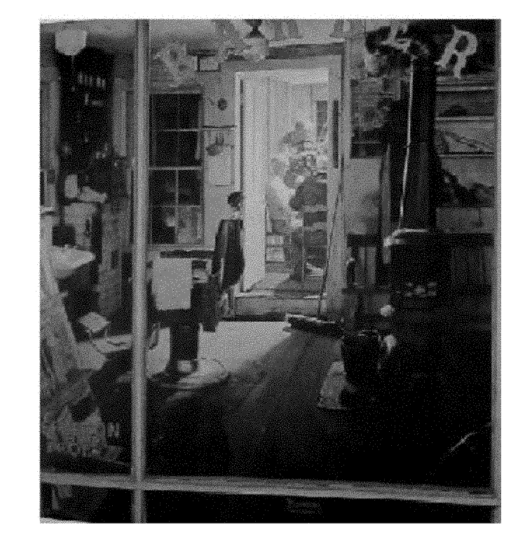

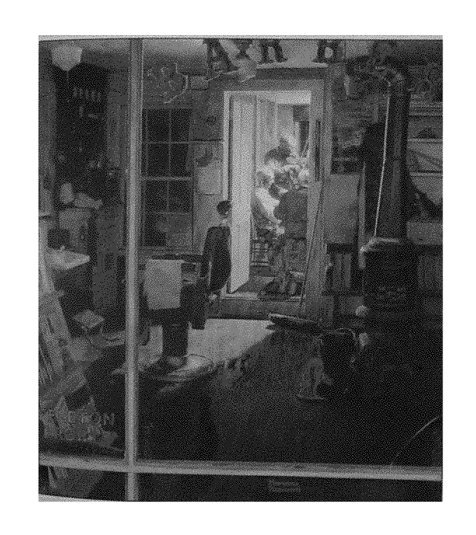

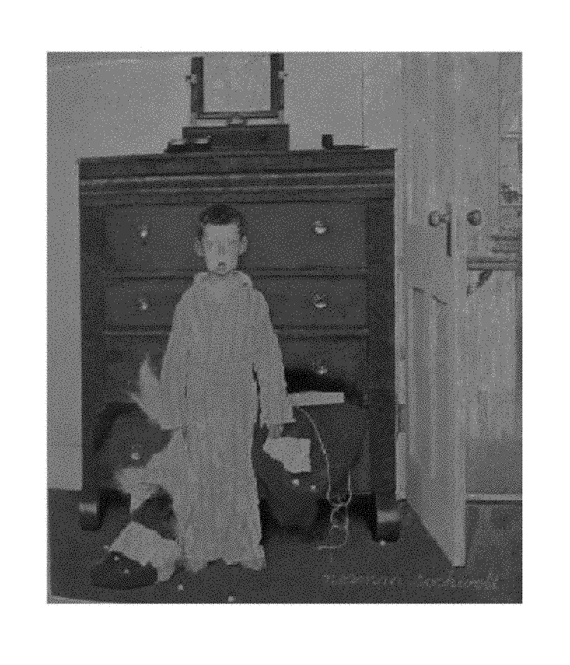

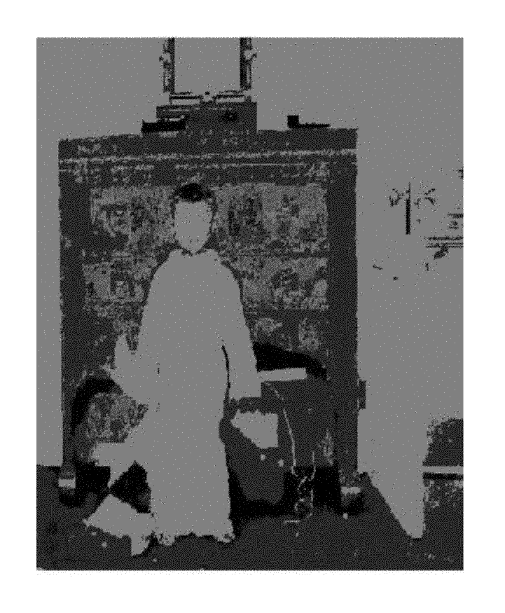

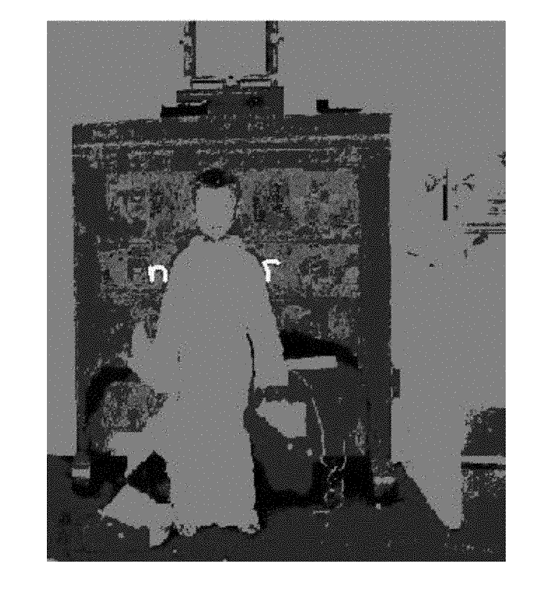

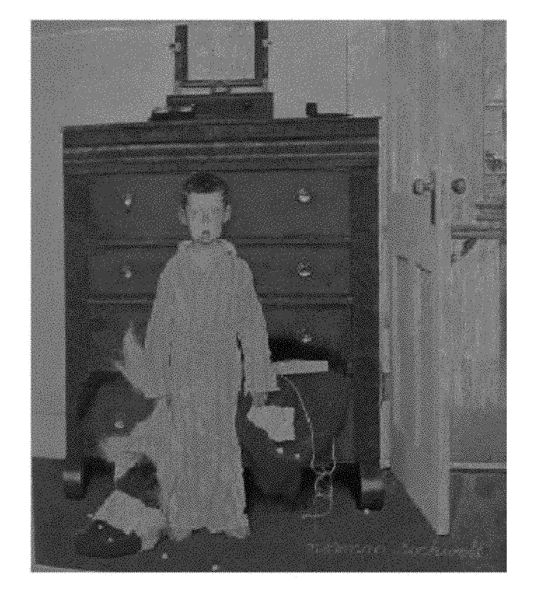

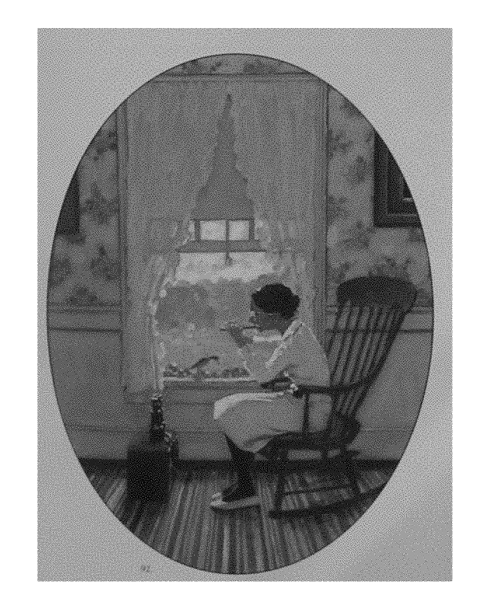

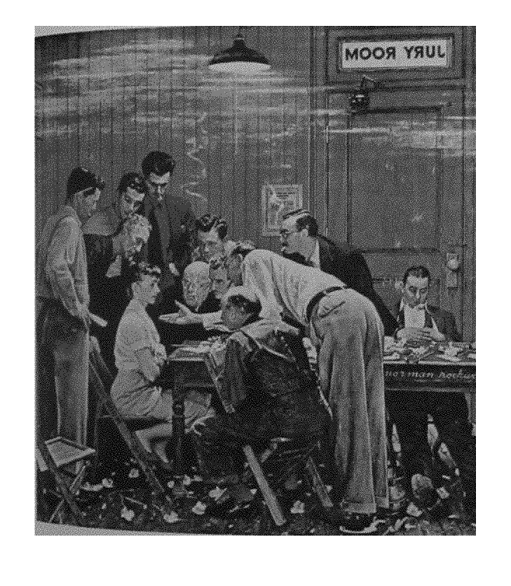

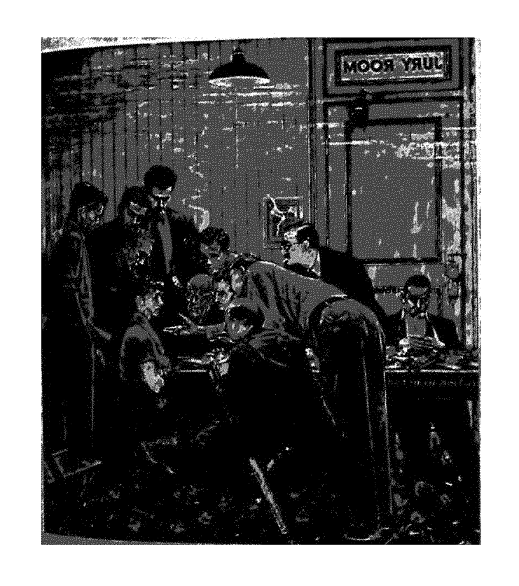

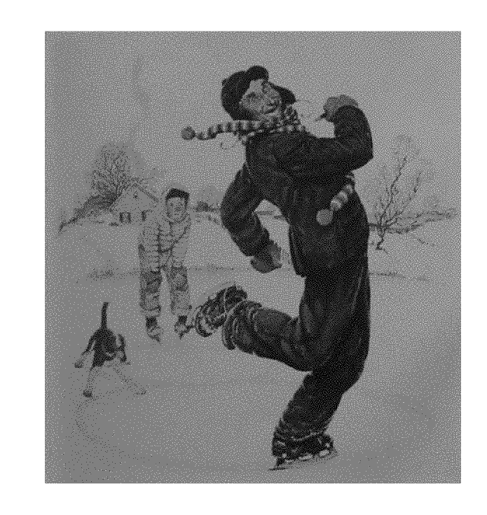

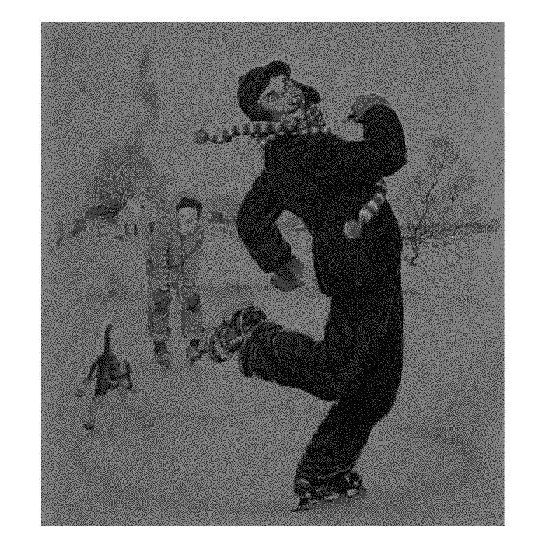

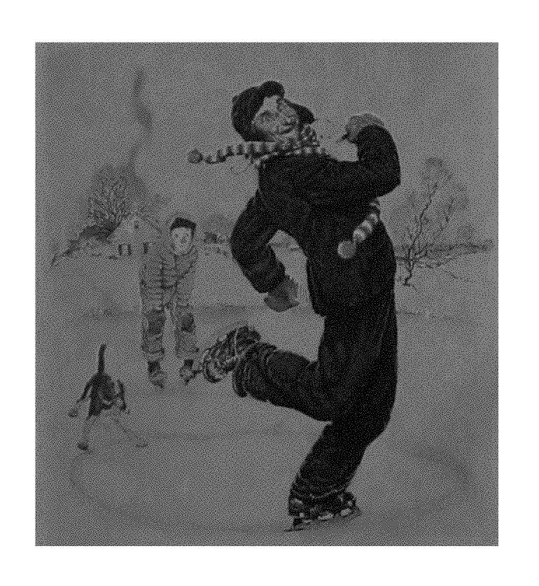

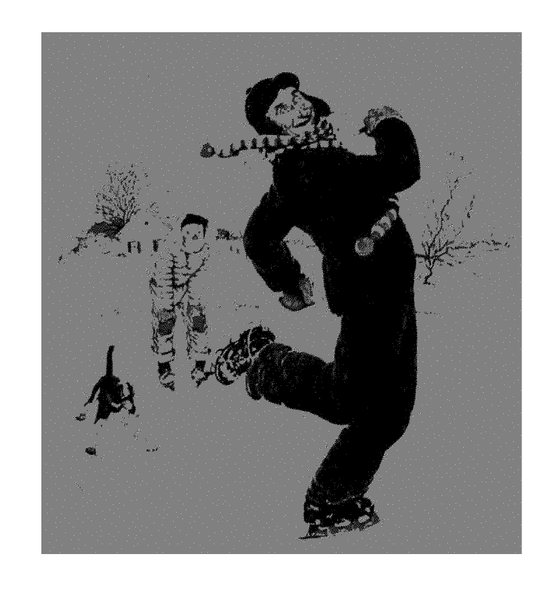

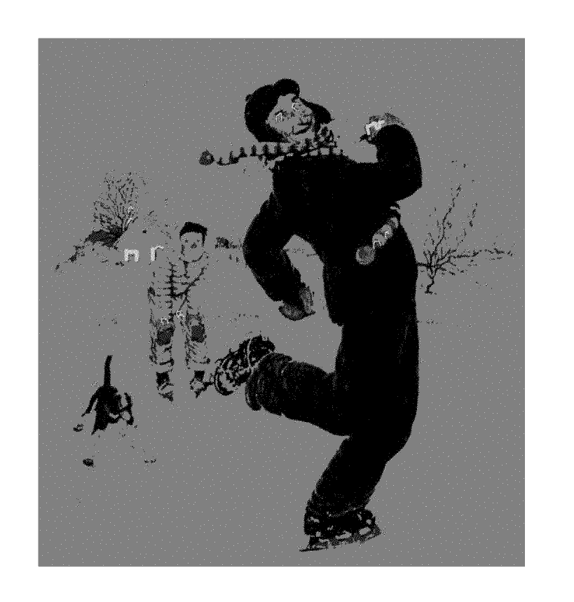

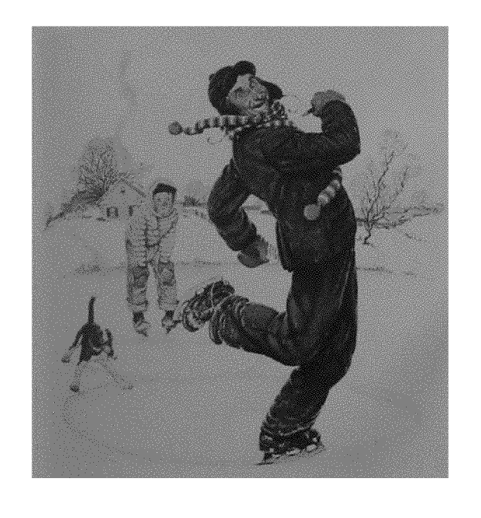

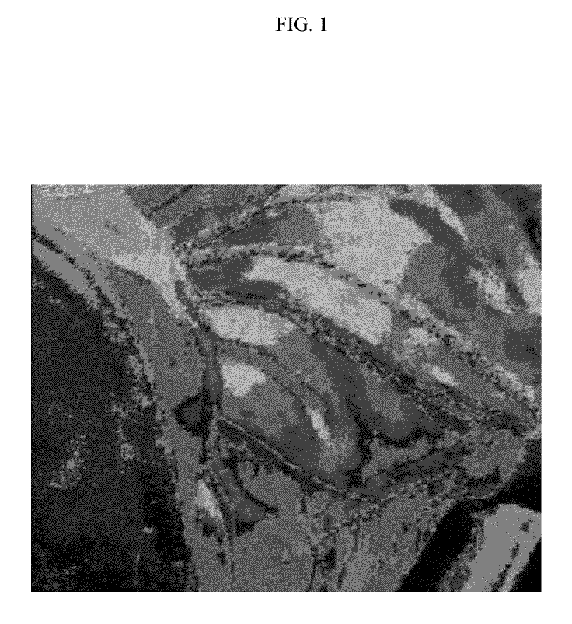

11. FIG. 1 Exploded view. Image of Voyeur after using Adobe, IrfanView and GIMP software to Posterize—Level 3 and magnify. This shows the space for the initials NR.

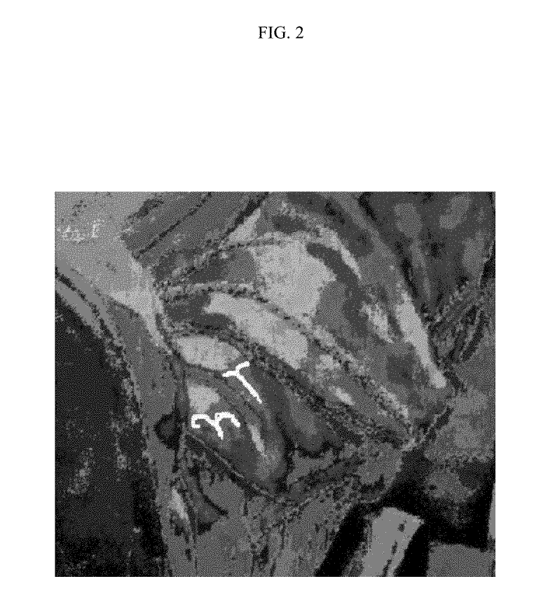

11. FIG. 2 Exploded view. Image of Voyeur after using Adobe, IrfanView and GIMP software to Posterize—Level 3 and magnify. Shows the space for the initials NR/RN with the initials highlighted in white.

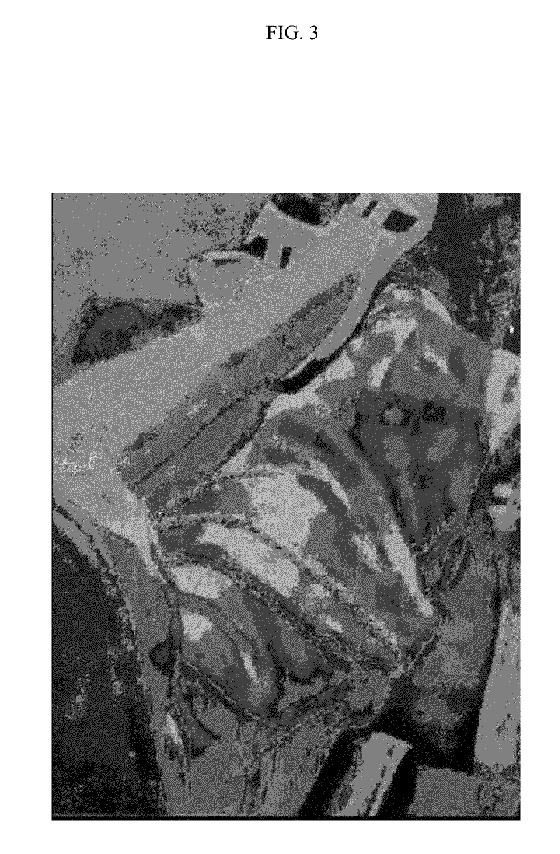

11. FIG. 3 Exploded view. Image of Voyeur after using Adobe, IrfanView and GIMP software to Posterize—Level 3 and magnify. Shows the space for the syllables NOR and MAN.

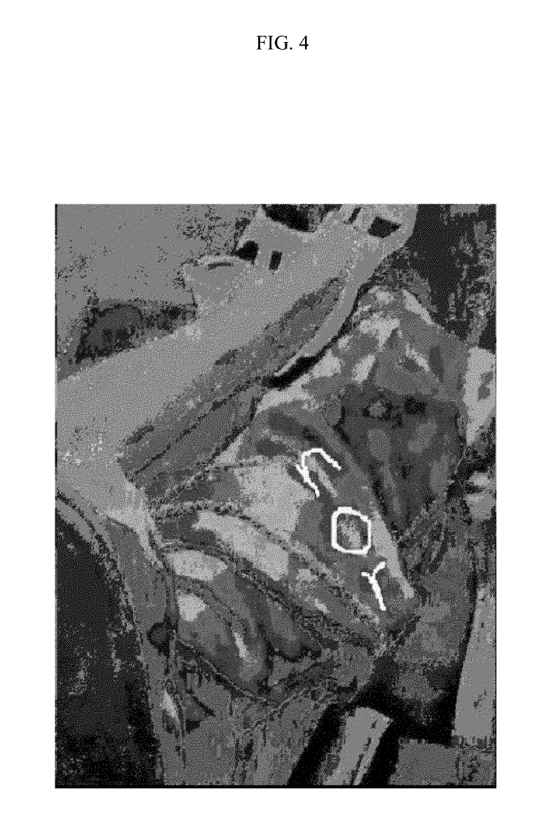

11. FIG. 4. Exploded view. Image of Voyeur after using Adobe, IrfanView and GIMP software to Posterize—Level 3 and magnify. Shows the syllable NOR highlighted in white.

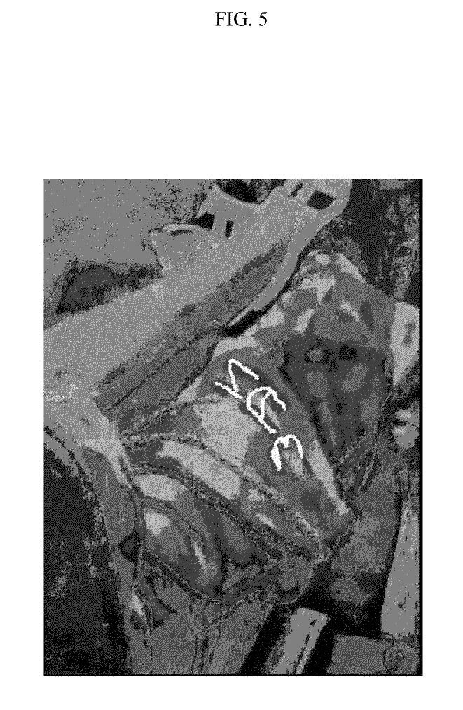

11. FIG. 5. Exploded view. Image of Voyeur after using Adobe, IrfanView and GIMP software to Posterize—Level 3 and magnify. Shows the syllable MAN highlighted in white.

12. Large format .jpeg image of the original painting, Portrait of General Eisenhower.

13. Image of Portrait of General Eisenhower after using Adobe, IrfanView and GIMP software to Posterize—Level 2. Shows the initials NR on the forehead.

14. Large format .jpeg image of the original painting, Saying Grace.

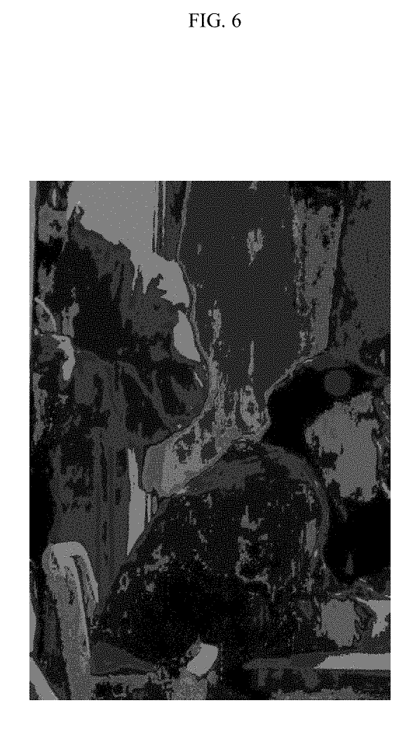

14. FIG. 6. Exploded view. Image cropped from Saying Grace after using Adobe, IrfanView and GIMP software to Posterize—Level 3 and magnify. Shows the section where he initials NR/RN appear.

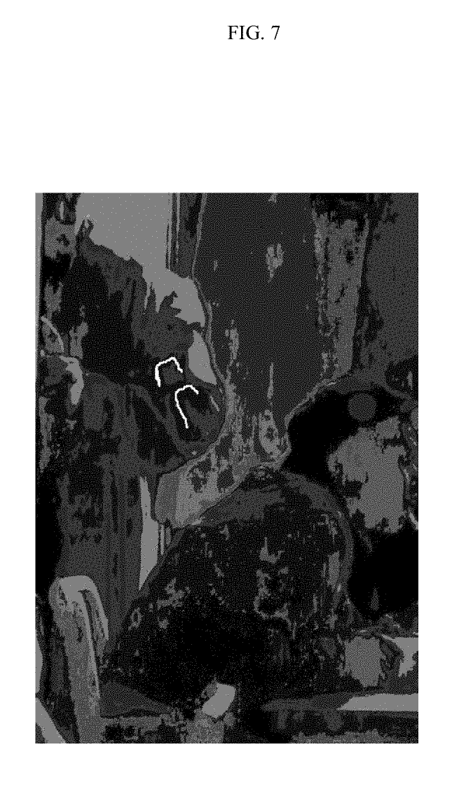

14. FIG. 7. Exploded view. Image cropped from Saying Grace after using Adobe, IrfanView and GIMP software to Posterize—Level 3 and magnify. Shows the section where he initials NR/RN appear with the initials NR/RN highlighted in white.

15. Large format .jpeg image of the original painting, Freedom from Want.

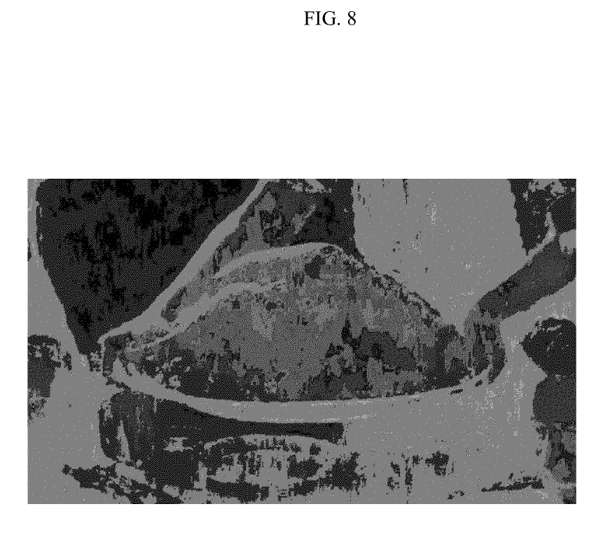

15. FIG. 8. Exploded view. Image cropped from Freedom from Want after using Adobe, IrfanView and GIMP software to Posterize—Level 3 and magnify. Shows the section where the initials NR/RN appear.

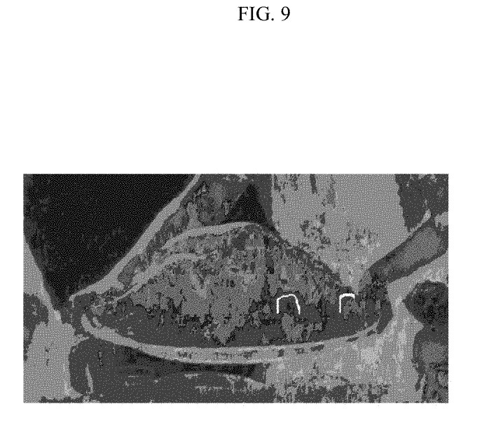

15. FIG. 9. Exploded view. Image cropped from Freedom from Want after using Adobe, IrfanView and GIMP software to Posterize—Level 3 and magnify. Shows the section where the initials NR/RN appear with the initials NR highlighted in white.

16. Large format .jpeg image of the original painting, The Rookie.

16. FIG. 10. Exploded view. Image cropped from The Rookie after using Adobe, IrfanView and GIMP software to Posterize—Level 3 and magnify. Shows the section where the initials NR/RN appear.

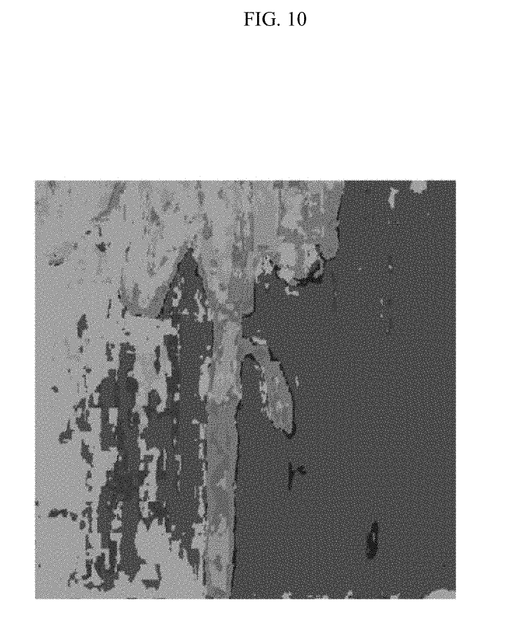

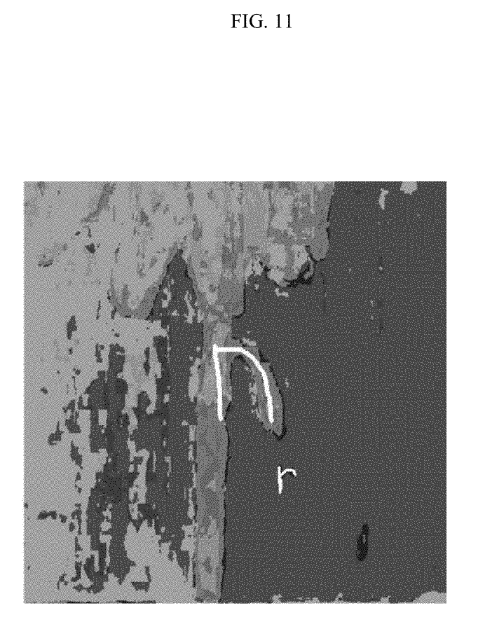

16. FIG. 11. Exploded view. Image cropped from The Rookie after using Adobe, IrfanView and GIMP software to Posterize—Level 3 and magnify. The initials NR are highlighted in white.

17. Large format .jpeg image of the original painting, Marriage Counselor.

18. Image of Marriage Counselor after using Adobe, Irfanview and GIMP software to Posterize—Level 2. This image shows the section where the initials NR appear.

19. Image of Marriage Counselor after using Adobe, Irfanview and GIMP software to Posterize—Level 2. This image shows the section where the initials NR appear with multiple sets of the initials NR/RN highlighted in white.

20. Large format .jpeg image of the original painting, Shulfleton's Barbershop.

21. Image of Shulfleton's Barbershop after using Adobe software and IrfanView software with the Adobe 8BF Plug-in Smart Curve to convert image to the HSB/HSV format.

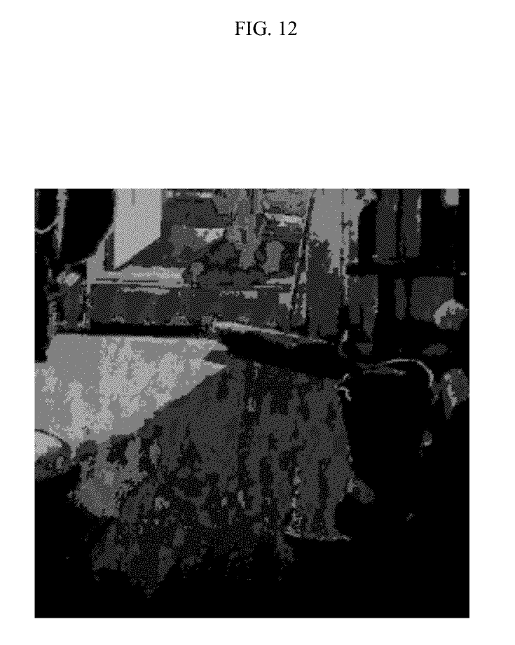

21. FIG. 12. Exploded view. Image cropped from Shulfleton's Barbershop after using Adobe, IrfanView and GIMP software to Posterize—Level 3 and magnify. This section of the painting is where the initials NR/RN appear.

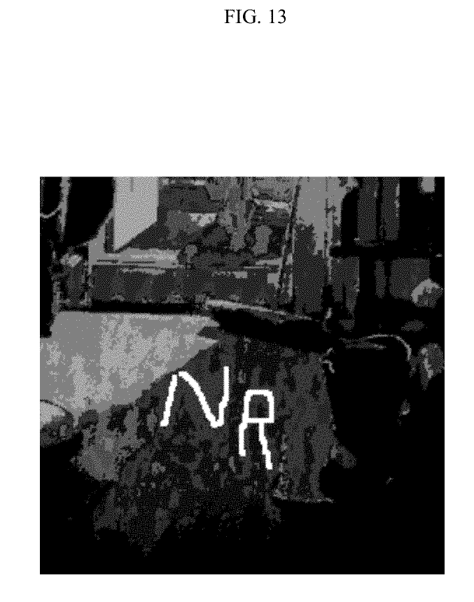

21. FIG. 13. Exploded view. Image cropped from Shulfleton's Barbershop after using Adobe, Irfanview and GIMP software to Posterize—Level 3 and magnify. The image shows the section where the initials NR/RN appear with the initials NR/RN highlighted in white.

22. Large format .jpeg image of the original painting, Discovering Santa.

23. Front Page view. Image of Discovering Santa after using Adobe, IrfanView and GIMP software to Posterize—Level 3. This image shows the section where the initials NR/RN appear.

24. Image of Discovering Santa after using Adobe, IrfanView and GIMP software to Posterize—Level 3. This image shows the section where the initials NR/RN appear with the initials NR highlighted in white.

25. Large format .jpeg image of the original painting, Discovering Santa.

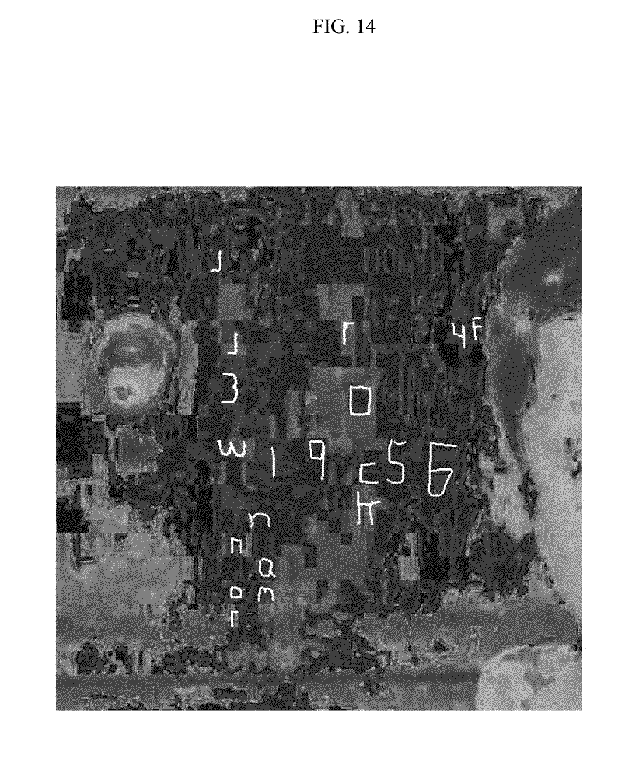

25. FIG. 14. Exploded view. Cropped image from Discovering Santa after using Adobe, IrfanView and GIMP software to Posterize—Level 2, Color Balance and magnify. This shows the section where the syllables of the name and the year of completion are located with ROCK, WELL, NOR, MAN and 1956 highlighted in white.

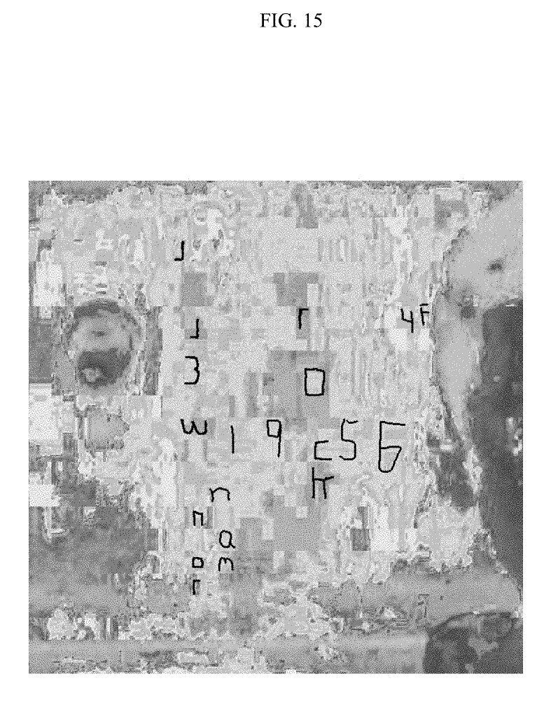

25. FIG. 15. Exploded view. Cropped image from Discovering Santa after using Adobe, IrfanView and GIMP software to Posterize—Level 2, Color Invert, Color Balance and magnify. This shows the section where the syllables of the name and the year of completion are located with ROCK, WELL, NOR, MAN and 1956 highlighted in black.

26. Large format .jpeg image of the original painting, Willie Was Different.

26. FIG. 16. Exploded view. Cropped image from Willie Was Different after using Adobe, IrfanView and GIMP software to Posterize—Level 2 and magnify. This image shows the section where the initials NR/RN appear.

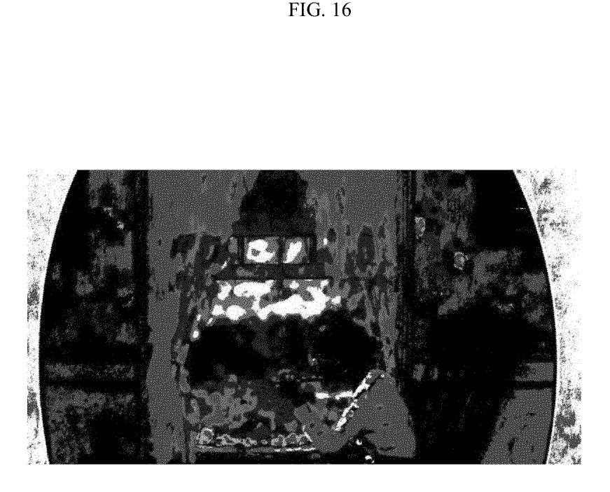

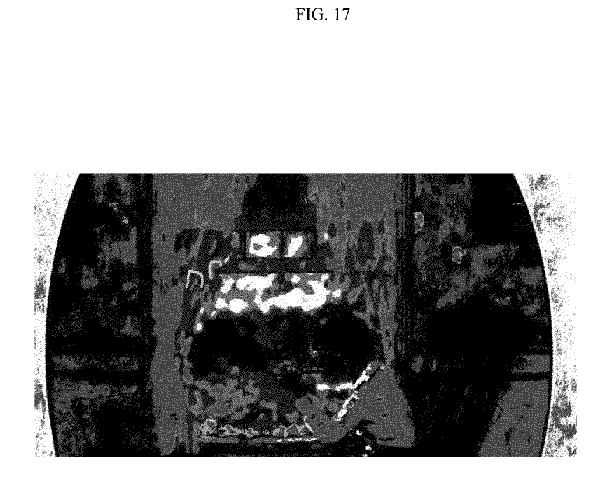

26. FIG. 17. Exploded view. Cropped image from Willie Was Different after using Adobe, IrfanView and GIMP software to Posterize—Level 2 and magnify. This image shows the section where the initials NR/RN appear with the initials NR highlighted in yellow.

26. FIG. 18. Exploded view. Cropped image from Willie Was Different after using Adobe, IrfanView and GIMP software to Posterize—Level 2 and magnify. This shows the section where the syllables of the name and the year of completion are located with ROCK, WELL, NOR, MAN and 1967 highlighted in white.

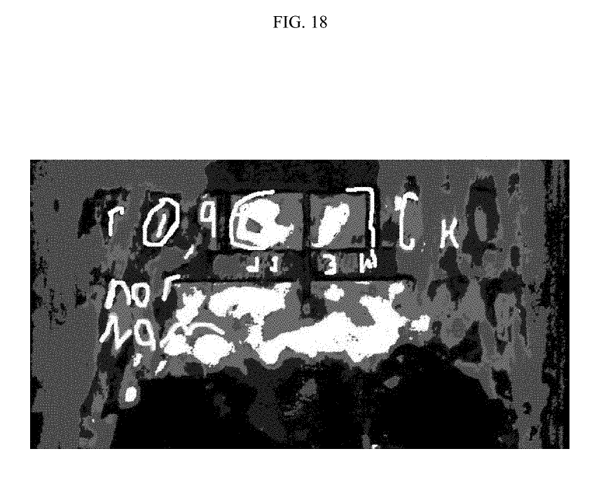

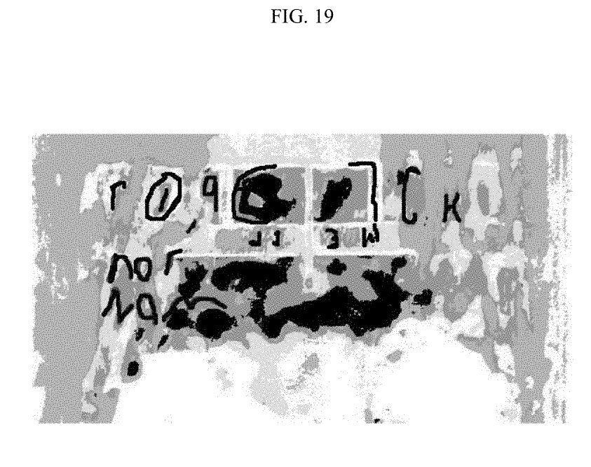

26. FIG. 19. Exploded view. Cropped image from Willie Was Different after using Adobe, IrfanView and GIMP software to Posterize—Level 2, Color Invert, Color Balance and magnify. This shows the section where the syllables of the name and the year of completion are located with ROCK, WELL, NOR, MAN and 1967 highlighted in black.

27. Large format .jpeg image of the original painting, Jury Room.

28. Image of Jury Room after using Adobe, IrfanView and GIMP software to Posterize—Level 3.

28. FIG. 20. Exploded view. Cropped image from Jury Room after using Adobe, IrfanView and GIMP software to Posterize—Level 2. This shows the section where the initials NR/RN appear.

28. FIG. 21. Exploded view. Cropped image from Jury Room after using Adobe, IrfanView and GIMP software to Posterize—Level 2. This shows the section where the initials NR/RN appear with the initials NR highlighted in white.

29. Large format .jpeg image of Grandpa and Me.

30. Image of Grandpa and Me after using Adobe software to convert the image to the CMYK color model.

31. Image of Grandpa and Me after using Adobe software to convert to the CMYK model and IrfanView software with the Adobe 8BF Plug-in and Smart Curve to convert the image to the HSB/HSV Color Model.

32. Image of Grandpa and Me after using Adobe, IrfanView and GIMP software to Posterize—Level 3.

33. Image of Grandpa and Me after using Adobe, IrfanView and GIMP software to Posterize—Level 3. This section shows multiple NR/RNs highlighted in yellow.

34. Large format .jpeg image of Grandpa and Me.

34. FIG. 22. Exploded view. Cropped image from Grandpa and Me after using Adobe, IrfanView and GIMP software to Posterize—Level 3 and magnify. This shows the section where the syllables of the name and the year of completion are located.

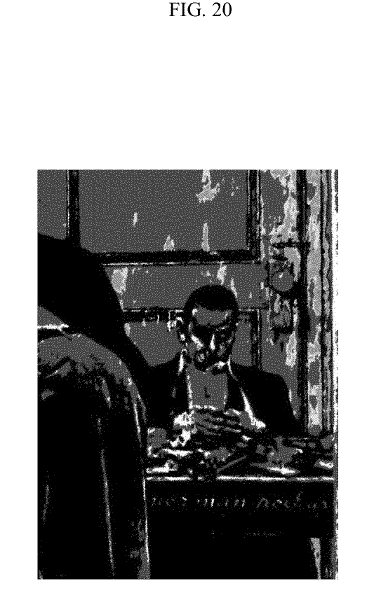

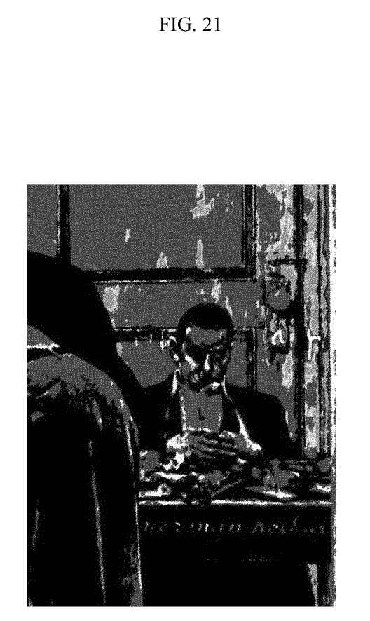

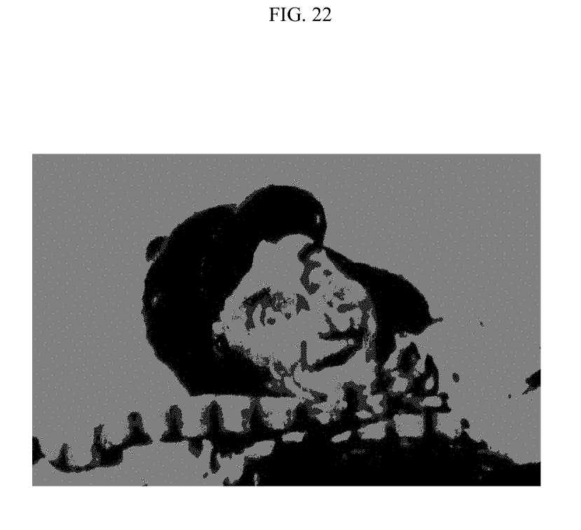

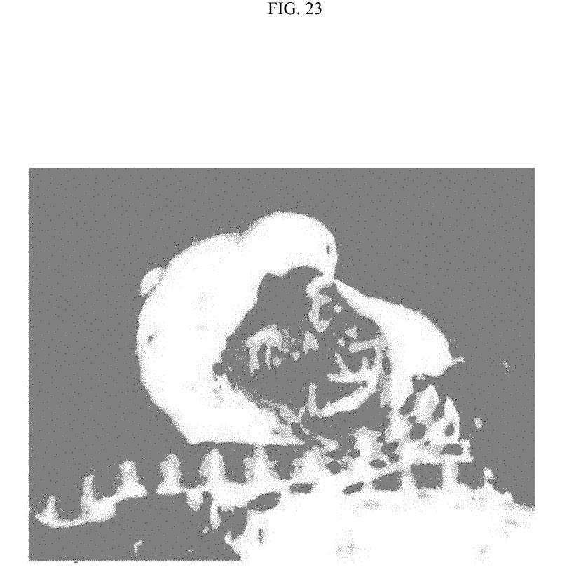

34. FIG. 23. Exploded view. Cropped image from Grandpa and Me after using Adobe, IrfanView and GIMP software to Posterize—Level 3, Color Invert and magnify. This shows the section where the syllables of the name and the year of completion appear.

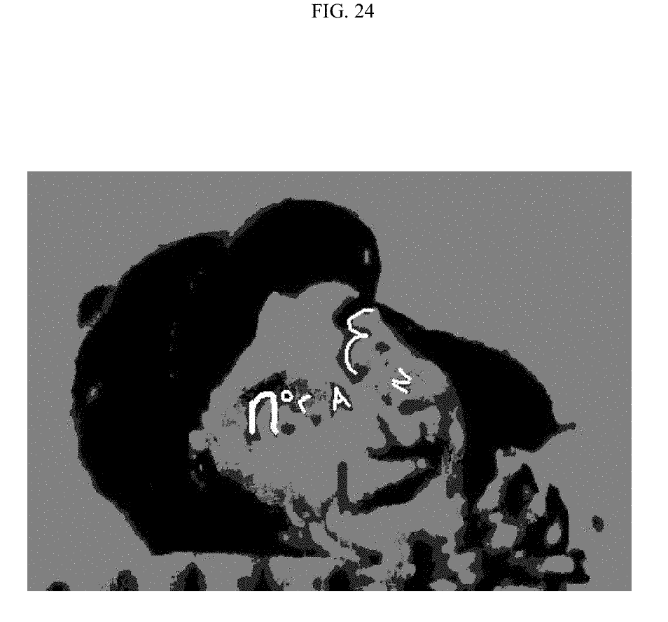

34. FIG. 24. Exploded view. Cropped image from Grandpa and Me after using Adobe, IrfanView and GIMP software to Posterize—Level 3 and magnify. This shows the section where the syllables of the name and the year of completion are located with NOR and MAN highlighted in white

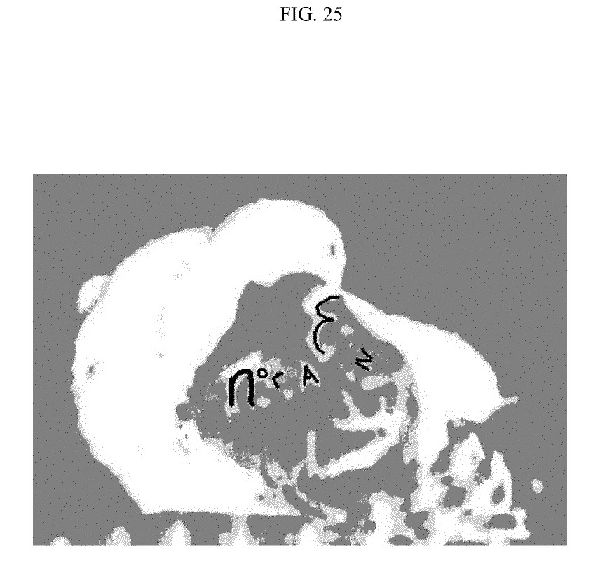

34. FIG. 25. Exploded view. Cropped image from Grandpa and Me after using Adobe, IrfanView and GIMP software to Posterize—Level 3, Color Invert and magnify. This shows the section where the syllables of the name and the year of completion are located with NOR and MAN highlighted in black.

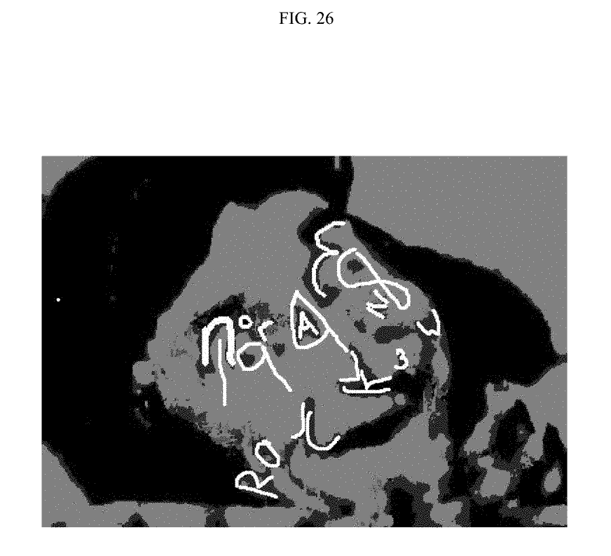

34. FIG. 26. Exploded view. Cropped image from Grandpa and Me after using Adobe, IrfanView and GIMP software to Posterize—Level 3 and magnify. This shows the section where the syllables of the name and the year of completion are located with ROCK, WELL, NOR, MAN and 1948 highlighted in white.

### DETAILED DESCRIPTION OF THE INVENTION

1. OPEN a large format jpeg of a Norman Rockwell painting completed after 1942 using Adobe Photoshop 7
a. Under the IMAGE pulldown menu, CLICK Mode.
b. Then CLICK CMYK Color.
c. Under the IMAGE pulldown menu, CLICK: Mode.
d. CLICK Convert to Profile
d. SELECT and SET the RGB profile. Check the box for Use Blackpoint Compression. Do not check the box for Use Dither. Set the Destination menu box to US Web Uncoated v2. In the Conversion Options box, Set the Engine to Adobe (ACE) and Set the Intention box to Perceptual.
e. CLICK OK,

2. Under the IMAGE pulldown menu, SELECT Adjustments to open the next menu.
a. SELECT Hue/Saturation.
b. SLIDE the setting for Saturation to 60.
c. CLICK on the arrow next to Master.
d. When the box opens, CLICK, Cyans.
e. SLIDE Hue setting to 57.
f. Click OK

3. Under the FILE pulldown menu:
a. CLICK Save As and SELECT the JPEG Format.
b. CLICK Save. This opens JPEG Options box.
c. SET the Image Options Quality box to HIGH and the Format Options box to Progressive with 5 scans.

4. CLICK OK See Drawings 3, 4, 10, 30

5. CLOSE Adobe Photoshop 7.

6. RE-OPEN the saved .jpeg image using the IrfanView software program.

7. Under the IMAGE pulldown menu, SELECT Adobe 8BF Plug-ins.

8. When the dialogue choices appear, CLICK Filter Dialogue.

9. When the Plugins Screen opens CLICK Smart Curve.

10. Then, CLICK Start Selected Filter.

11. When the Smart Curve menu opens, CHANGE Color Space to HSB/HSV.

12. In the box above HSB/HSV selection, there are three curves that can be adjusted.
a. Brightness—depending on quality of the original photo, slight adjustment to the curve may be needed.
b. Saturation—If the Brightness curve was adjusted, then adjust the Saturation curve by an equal amount but in the opposite direction of the Brightness adjustment.
c. Hue—ADJUST the Hue.
   1. PLACE the cursor on the Hue curve and use the mouse to hold the cursor on the curve.
   2. MOVE the curve with the mouse and the colors of the image change. Keep moving the curve until it reaches the point where the Cyan/Magenta hues are maximized. Depending on the image, this will be reflected by the IN measurement anywhere in the range between 28 and 58.
   3. RELEASE the mouse.
   4. CLICK OK This opens the IrfanView Adobe 8BF Filters box
   5. CLICK Exit.

13. Under the FILE pulldown menu:
a. CLICK Save As, SELECT the JPEG Format and CLICK Save. See Drawings 5, 6, 11, 21, 31.

14. CLOSE the IrfanView software program.

15. RE-OPEN the saved IrfanView .jpeg image from 13 above using the GIMP software program.

16. Under the TOOLS pulldown menu, SELECT Color Tools.
a. From the Color Tools selection menu, SELECT Posterize.
b. The .jpeg image will Posterize at Level 3 by default. See Drawings 7, 8, FIG. 1, FIG. 2, FIG. 3, FIG. 4, FIG. 5, FIG. 6, FIG. 7, FIG. 8, FIG. 9, FIG. 10, FIG. 11, FIG. 12, FIG. 13, FIG. 23, FIG. 24, FIG. 22, FIG. 23, FIG. 24, FIG. 25, FIG. 26.
c. The initials NR/RN appear most often in the colors Cyan, Red or Purple. If they are not readily apparent, a slight increase in the size of the image may be required.
d. If the initials are identified at Posterize—Level 3, skip to step 18.
e. There are many paintings where the initials NR/RN will not appear at Level 3.

17. If the initials NR/RN are not identified at Level 3 change the posterization level to Posterize—Level 2 See Drawings 18, 19, FIG. 14, FIG. 15, FIG. 16, FIG. 17, FIG. 18, FIG. 19, FIG. 20, FIG. 21.

18. Once the initials have been identified, CLICK OK on the Posterize screen.

19. Under the FILE pulldown menu, SELECT Save a Copy

20. Click Save. Make sure to remember where it has been saved.

21. If the initials NR/RN have not been identified, the painting is not an authentic Norman Rockwell painting. See Drawing 8. If the initials have been identified, continue to Step 22.

### Part Two of the Authentication Process

22. Using the original posterized image from 19 above, under the EDIT pulldown menu,

SELECT Undo Posterize.

23. Under the TOOLS pulldown menu, SELECT Transformation Tools.

24. SELECT Crop. Crop the image so that the area where the initials appeared will become the center of the new cropped image. The new cropped image must contain a broad area radiating from its centerpoint where the initials appeared.

25. Under the EDIT pulldown menu, CLICK Copy.

26. Under the FILE pulldown menu CLICK New and then OK.

27. Under the EDIT pulldown menu, CLICK Paste.

28. Repeat Steps 25 and 26 and make a second copy.

29. SAVE both jpeg copies for later use.

30. RE-OPEN one copy of the jpeg created and saved in Steps 25-28 above.

31. Under the TOOLS pulldown menu, SELECT Color Tools
a. From the Color Tools selection menu, SELECT Posterize

32. If the initials NR/RN in Step 16 above were noted at Posterize—Level 3 CLICK, OK. Otherwise, Posterize—Level 2 and CLICK, OK.

33. INCREASE the viewing size of the .jpeg to the 100%, 200% or 400% magnification level in order to identify the syllables/year of completion. See FIG. 1-26.

34. IDENTIFY each of the syllables and the space for the year completed. This is the most challenging part of the identification process and requires some practice. Use the second copy created in Steps 24-26 above.

35. RE-OPEN the second .jpeg image using the TOOLS pulldown menu and Color Tools sub-menu.

36. CLICK Posterize.
a. ADJUST the Posterize function level upward or downward in increments of one, until the syllables and year of completion are visible. OR
b. Use the COLORS drop down menu and SELECT Color Balance.
   (1). ADJUST the Cyan/Red, Magenta/Green or Yellow/Blue scales within each of the selection choices; Shadows, Midtones and Highlights to make the syllables and year of completion appear. OR
c. Use the COLORS drop down menu and SELECT Invert. Color Invert may make the syllables of the name or year of completion more apparent. See FIG. 15, FIG. 19, FIG. 23, FIG. 25.

37. When each syllable/year of completion is identified, go to the pencil function located under the TOOLS pulldown menu and Color Tools sub-menu. Click Pencil

38. Pencil-in each letter/numeral directly above where it appears in the .jpeg image. See FIG. 2, FIG. 4, FIG. 5, FIG. 7, FIG. 9, FIG. 11, Drawing 19, FIG. 13, Drawing 24, FIG. 14, FIG. 15, FIG. 17, FIG. 18, FIG. 19, FIG. 21, Drawing 33, FIG. 24, FIG. 25, FIG. 26.

39. When all the hidden data has been identified and penciled-in per Step 37 above, CLICK Save.

40. If the hidden data has not been identified, further investigation is warranted. That begins with repeating Steps 1-38 above, otherwise,
a. The Authentication Process for Post-1942 Norman Rockwell Paintings is complete.

The claim is:

1. A process to authenticate Norman Rockwell paintings completed after 1942.

2. The method of claim 1 further comprising;
Use of a large format digital photograph (1,000×1,025 mm or larger) of an actual painting or a photograph of a painting from a book containing oversized images.
The photograph must be in a .jpg or .jpeg format to facilitate the conversion of the image into different color models using readily available computer software programs and standard computer features.
The image conversion process works on computers running Windows operating systems.

3. The process requires the use of the Adobe Photoshop software program.

4. The method of claim 3 further comprising;
Use of the Adobe Photoshop software program to convert the image to the CMYK Color Model.
Use of the Adobe Photoshop software program to use the CMYK Color Model image and convert it to the to the CMYK format mode.
Use of the Adobe Photoshop software program and the CMYK format mode image to adjust the “Master” Saturation Level and the Hue Level for Cyans to maximize the cyan components of the image.
Saving the image for later use with the IrfanView software program.

5. The method of claim 4 further comprising;
Use of the IrfanView software program. This program only functions on Windows operating system computers.
Installation of the Adobe 8BF plugin called “Smart Curve” as a plugin for the IrfanView software program.
Use of the Smart Curve plugin and choice of the HSB/HSV Color Model to adjust the Hue level to maximize the cyan and magenta components of the image.
Use of the Smart Curve plug-in in the HSB/HSV Color Model to make any slight adjustments needed to the Brightness and Saturation levels.
Saving the adjusted image for later use with the GIMP or Adobe Photoshop software program.

6. The method of claim 5 further comprising;
Use of the GIMP software program or the Adobe Photoshop software program to Posterize the adjusted image.
Norman Rockwell's initials will appear as either NR or RN in all paintings completed after 1942 in a variety of handwriting styles. The initials will stand out prominently at either Posterize—Level 3 or Posterize—Level 2.
The Posterize levels necessary to reveal all of the hidden information occurs between Level 9 and Level 2.
Saving the Posterized image at the appropriate levels for authentication reports.
Enlarging the area immediately surrounding the initials to between 100%-400% magnification to reveal the syllables of Mr. Rockwell's first and last names and the year of completion of the painting.
Identifying the syllables of the first and last names. These appear as “nor,” “nam,” “rock” and llew.”
If necessary, using the GIMP or Adobe Photoshop software programs to invert the colors, color balance the image or to adjust the Posterization level to facilitate the identification of the syllables of the names and the year of completion.

7. Creating a database of all Norman Rockwell paintings showing the variety of styles and colors he used for his Steganographic anti-forgery technique for future reference.
